(19) United States
(12) Patent Application Publication
(10) Pub. No.: US 2005/0220169 A1
(43) Pub. Date: Oct. 6, 2005

(54) Monitoring device

(76) Inventor: Martin McGowan-Scanlon, Blackpool Sands (GB)

Correspondence Address: NIXON & VANDERHYE, PC, 901 NORTH GLEBE ROAD, 11TH FLOOR, ARLINGTON, VA, 22203, US

(21) Appl. No.: 10/512,197

(22) PCT Filed: Apr. 17, 2003
(86) PCT No.: PCT/GB03/01662

§ 371 Date: Oct. 22, 2004

(30) Foreign Application Priority Data
Apr. 23, 2002 (GB) 0209203.9

(51) Int. Cl. G01K 1/08; G01K 13/00; G01K 1/14

(52) U.S. Cl. 374/156

(57) ABSTRACT

A liquid monitoring device which floats in liquid such as swimming pools and the like includes a signal element able to indicate a property of liquid and arranged to float above the surface of the liquid, an elongate housing extending below the signal element and arranged so that it is below the surface of liquid when the device is floating therein, and a sensor arranged at an end region of the housing remote from the signal element and arranged to measure at least one property of the liquid, and a device to transmit information from the sensor to the signal element.

The present invention relates to a liquid monitoring device, in particular for use in swimming pools, baths, hot-tubs, spas and the like.

It is frequently necessary to monitor water for properties such as temperature, pH, or chemical composition, such as the level of sanitising chemicals such as chlorine, bromine or ozone, in bodies of liquid. The temperature of water in baths and swimming pools is generally elevated to levels that are comfortable to the user. However care must be taken to ensure that they do not reach unhealthy levels, for example, at levels at which there is a danger of scalding.

Furthermore, the chemical nature of the water in swimming pools and the like, for example, the p.H. and the chemical composition, in particular the levels of purifying or sanitising chemicals must be regularly monitored to ensure that they remain within a safe range. The conditions must be such as to prevent or control the growth of organisms such as algae or bacteria and the like, and maintain clear water by reduction of T.D.S. but not at levels at which the chemicals themselves may have a detrimental effect on the health of bathers. In particular it is necessary to prevent the growth of algae and maintain a balance of bacteria levels within a pool.

Monitoring devices and procedures are well known but they tend to be labour and time intensive, requiring repeated water sampling, or immersion and reading of mercury or alcohol thermometers or other temperature measuring devices in the liquid.

A number of floating monitoring devices have previously been proposed, for example U.S. Pat. No. 5,681,110, U.S. Pat. No. 5,169,236 and U.S. Pat. No. 4,503,563. These devices are, by and large, operated by electrical power from batteries or cells such as solar cells. They include sensors which become immersed in the water, and transmit signals to a display device which is visible above the water level whilst the device is floating in the liquid.

A difficulty with these devices is that they measure the conditions at the surface of the liquid. This is not always appropriate. For example, for temperature measurement, it is recommended that the temperature of water below the surface is monitored. This gives a more accurate measure of the water temperature, as the effect of thermals is averaged out. Also, the chemical composition at the surface of the liquid may not truly represent the composition of the water as a whole as a result of evaporation effect. They may also be unstable if there is turbulence in the water.

According to the present invention there is provided a liquid monitoring device which floats in liquid, comprising a signal element able to indicate a property of liquid and arranged to float above the surface of said liquid, an elongate housing extending below said signal element and arranged so that it is below the surface of liquid when the device is floating therein, and a sensor arranged at an end region of said housing remote from the signal element and arranged to measure at least one property of said liquid, and means for transmitting information from said sensor to said signal element.

The elongate housing of the device of the present invention means that readings from the recommended depth within the liquid can be readily taken. Furthermore, the elongate housing acts as a keel, keeping the device floating upright in the liquid.

Suitably the elongate housing is such that the sensor is located from 15 to 45 cm below the surface of the liquid in which the device is placed, and preferably at about 30 cm below the surface. In particular the elongate housing may be from 28 to 32 cm long. Generally speaking the elongate housing will be watertight, although it will be necessary to ensure that the sensors project into the liquid so that the target property may be measured.

The sensor is suitably one that is adapted to measure temperature, pH, and/or chemical composition, for example the chlorine content, of said liquid. If desired, more than one sensor may be included in the housing. Suitable electronic sensors are available commercially for example from Analytical Sensors Inc., USA.

Preferably, the sensor, the means for transmitting information from said sensor to said signal element and/or the signal element contained within the device are powered electrically using cells such as batteries, which may or may not be rechargeable, and/or solar cells. Suitable batteries for use in the invention include alkali batteries, as well as lithium carbide batteries. They are suitably long-life batteries, which reduce the frequency at which the batteries need to be changed.

Where the device is powered by batteries, these are suitably accommodated within the elongate housing, which is shaped accordingly and which is watertight. The elongate nature of the housing means that there is a possibility that the batteries may be connected in parallel. Furthermore, the presence of batteries increases the weight of the housing and so improves the stabilising properties.

Where the device is powered by solar cells, these are suitably arranged in an upper portion of the device so that they remain above the surface of liquid in which the device is floating. The device may include light reflecting surfaces arranged to direct as much light as possible onto the solar cells. An example of an arrangement of solar cells is given in U.S. Pat. No. 5,681,110.

If required, solar cells may be used in addition to a conventional battery, and arranged so that one acts as the primary power source and one acts as a back-up power source. Where rechargeable batteries are used, the solar cells may be used to charge these.

The signal element included in the device may comprise a visible display. This is suitably housed within a container, which is at least partially transparent so as to allow the display to be viewed, in an upper portion of the device. Preferably, the container is completely transparent. It may have various shapes, and may include portions, which can act as lenses to enhance the visibility of the display. Furthermore, it is suitably sealed and is shaped or contains a suitable air pressure to ensure that the device is buoyant to the extent that the signal element is visible above the surface of the water.

Suitably the display is a digital display and in particular comprises a liquid crystal display element, as are well known in the art. It may take various forms, including the presentation of figures indicating the status of the property being measured by the sensor or sensors, as well as graphical representations of the status.

Optionally the device further comprises illumination means such as lamps or light bulbs, to improve the visibility of the display, or to allow it to be read at night.

Alternatively or additionally, the signal element may comprise a transmitter, able to transmit information to a remote receiving station. This station may be located for example on the side of the pool, or it may be located in the offices of a pool monitoring company. The remote receiving station suitably comprises a display device that may include visible displays and/or or audible alerting devices. For example, visible displays such as those described above, may then be produced on a noticeboard or the like at the side of the pool.

The remote receiving station may also be connected to control devices, such as pool heaters, or chemical supply arrangements which may then be able to automatically adjust the conditions of the pool in response to the signal.

The transmitters used in the device may be radio-transmitters, as well as infrared transmitters and the line. Where radio-transmitters are used, there are suitably are able to transmit radiosignals at different frequencies, so that a wavelength may be selected which does not interfere with other local transmitters.

If desired, multiple devices can be floated in different areas of a body of liquid such as a swimming pool, at any one time, each transmitting signals to the same receiving station, which may then combine the values so that an average value is displayed.

In any case, the signal element may further comprise means that gives a visible or audible alarm when the property being measure falls outside acceptable limits.

Where the device includes more than one sensor, more than one property may be measured at any one time. The results may be displayed simultaneously if required, provided a suitable display element is employed. Alternatively, switching means may be provided either on the device itself, or where present on the remote receiving station, to allow the display to be switched between the different properties.

Suitably the electronic circuit responsive to the sensor is adjustable so that the device may be set to record the preferred levels of the target properties for the end user. For example, it would preferably be possible for the results of temperature measurements to be displayed in degrees centigrade or Fahrenheit. Also electronics are suitably adaptable to accommodate the use of different pool chemicals such as chlorine, bromine or ozone. Readings may be taken continuously or at intervals, and in the latter case, the frequency of the readings may be adjustable depending for example on whether the pool is subject to light, medium or heavy use.

The device of the invention may further comprise a shock absorber, arranged to minimise the effects of the device colliding with, for instance the side of a swimming pool, when in use. This may take the form of rubber or inflatable sections, arranged around the upper portion of the device. If the material of this shock absorber is selected appropriately, this may act as a supplementary buoyancy aid to ensure that the device floats upright in liquid.

Preferably, the said elongate housing is removeable to allow the sensors and/or any batteries contained within it to be changed. Thus, the housing is suitably attached to the upper part of the device comprising the signal element, by means of a releasable connection. This connection should be watertight to prevent liquid entering the housing through the joint when the device is floating in the liquid. In one embodiment, this may be achieved using a screw-threaded collar arrangement, combined if necessary with water-tight seals such as may be provided by rubber or plastics O-rings, or by gaskets or the use of sealant compounds such as silicones.

Elements of the device may be supplied separately. In particular, elongate housings for use in a device as described above may be provided separately, preferably with an associated sensor or sensors integrated therein, to ensure that the seals between the sensor and the housing remain intact. These form further aspects of the invention.

The invention will now be particularly described by way of example with reference to the accompanying diagrammatic drawings in which:

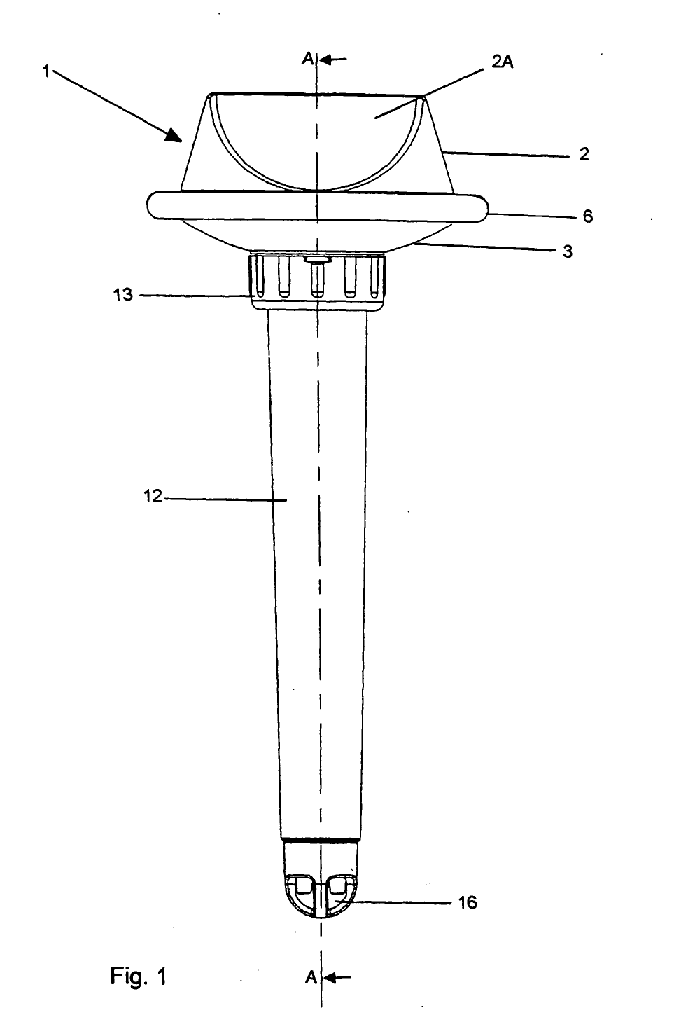

FIG. 1 is a front view of a device of the invention;

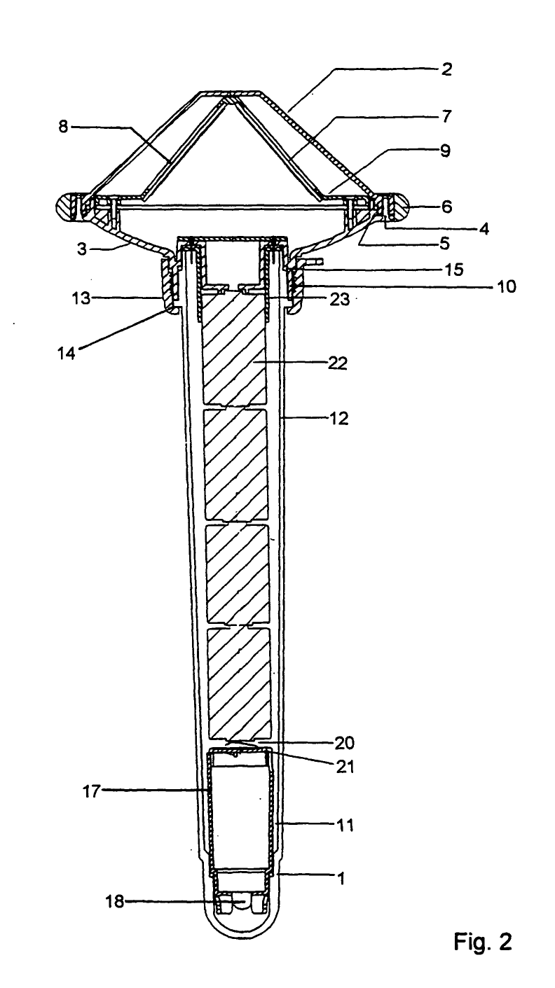

FIG. 2 is a section one line A-A of FIG. 1;

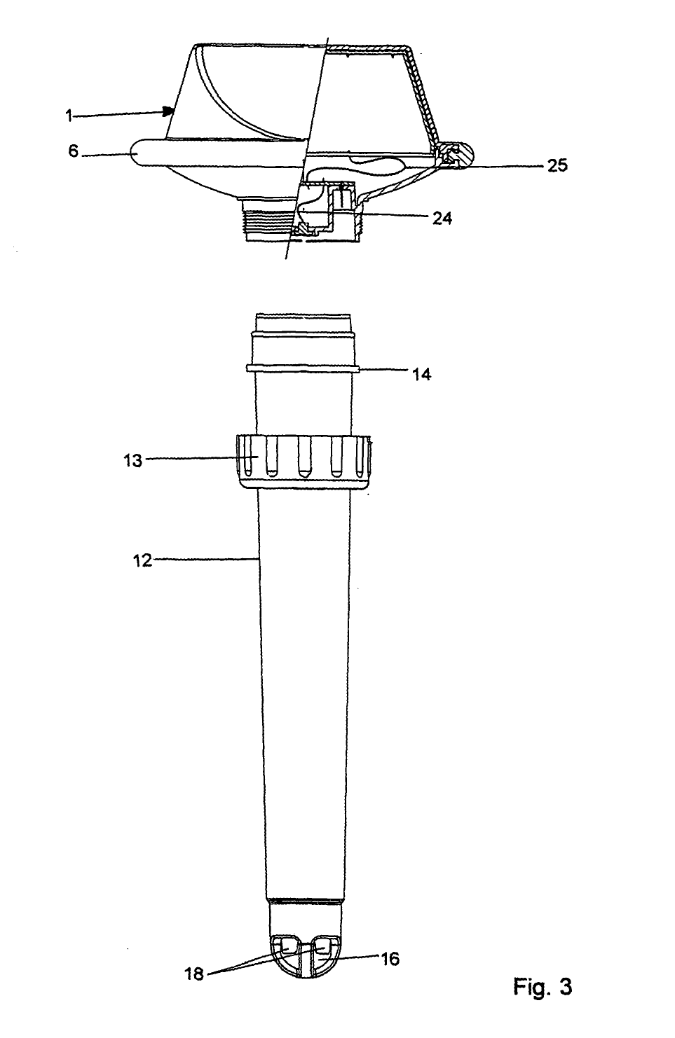

FIG. 3 is an exploded front view, partially in section of the device of FIG. 1; and

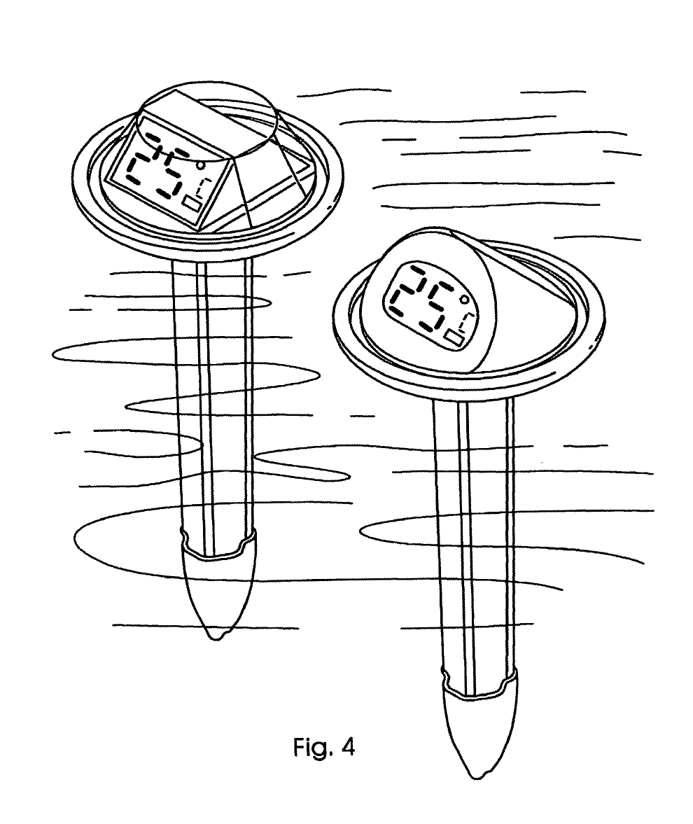

FIG. 4 is a perspective view showing the device of FIG. 1 and a similar device, floating in water.

The illustrated devices (FIG. 1) comprise a “head element” (1) comprising an upper transparent portion (2) fixed to a lower body portion (3) by means of a series of screw fixings (4)(FIG. 2). The upper portion (2) is suitably of a transparent plastics material such as a clear polycarbonate. It is suitably shaped so as to provide a lens area (2A) through which the contents of the head element (1) are clearly visible.

The joint between upper and lower portions (2,3) of the head element is made watertight by the provision of an “O” ring seal (5), which is compressed between mating surfaces. Gaskets or sealing compounds such as silicones, may be employed in place of the “O” ring if required.

The joint area is surrounded by an outer ring (6) of a plastics or rubber material. This acts as a shock absorber when for instance, the device collides for example with a wall of the pool or bath. Depending upon the nature of material of the ring (6), it may also assist in the buoyancy of the device.

Contained within the upper portion (2) and visible from either side of the head element (1) is a pair of inclined digital liquid crystal display devices (7,8), each supported at their lower ends on a platform (9) connected to the body portion (3) of the head element (1) and fixed at the top to the upper portion (2). The angle at which the display devices (7,8) are inclined is selected so that they may be readily readable from the side of a pool in which the device is floating.

The lower portion (3) of the head element (1) is suitably of a hard plastics material such as a polycarbonate material. It is provided with a downwardly projecting annular flange (10) in the centre, which is arranged to accommodate an upper portion of an elongate cylindrical housing (12). The outer surface of the flange (10) is screw threaded to allow it to be connected to the housing (12) by means of a collar (13), which has an internal screw thread and which is arranged to abut against an annular flange (14) projecting from the side of the housing (12). A further O-ring (15) is provided to form a water-tight seal between the housing (12) and the lower portion (3) of the head element.

The lower end of the elongate housing (12) is provided with a series of openings (16). It is also shaped to accommodate the body (11) of a probe or sensor (17). An O-ring (18) is provided to form a watertight seal between the body (11) and the housing (12).

When the probe (17) is contained within the housing (12), sensory elements (19) are arranged below the O-ring seal (18) and therefore are exposed via the openings (16) to the surroundings.

The probe (17) may include one or more set of sensory elements (19) as are understood in the art. These include temperature sensors such as thermistors, pH sensors and/or oxidation reduction potential sensors as are well known in the art and are described for example in U.S. Pat. No. 5,681,110. They generally provide a variable voltage in direct relation to the property they are measuring. The voltage information is processed on a circuit board (not shown) and generates a signal, usually an analogue or digital signal, which may be used to drive the liquid crystal display devices (7,8) as would be understood in the art. The circuit board may be suitably be contained within the device either within the probe body, or more usually, within the head element (1). An amplifier circuit (not shown) may be provided in the probe body if for example, spurious signals are affecting the result and/or the signal has to be transmitted over a large distance.

The top of the probe (17) is provided with an electrical contact (20), fitted to a cap of the probe (21). A cluster of batteries (22) in series alignment is provided in the housing (12) fitted between a contact (20) on the top of the probe (17) and a tube end moulding (23) provided in the head element (1).

A voltage differential signal recordable in millivolts, is sent from the probe (17) to the electronic circuit board in the head element (1) via a series of shielded cables (24, 25) (FIG. 3). They electronic circuit board include software which is able to interpret variations in the signals, based upon the preferences and configuration of the controls. These preferences and configurations may be preset, or may be adjustable by the user.

In use, the device of the invention is floated in liquid such as the water in a swimming pool or the like (FIG. 4). The device is designed so that when floating, the housing (12) and the lower body portion (3) are submerged, with the water surface at the level of the ring (6).

Water contacts the sensor elements (19) through the openings (16) in the lower portion of the housing (12). These elements form part of a circuit which includes the batteries (22) and the liquid crystal displays (7,8). Specifically, the sensor (19) is sensitive to various conditions in the water, such as temperature, which create small variations in the electrical signals being sent to the electronic circuit board. These variations are interpreted by the software in the device, which then produce an appropriate visible read-out on the display elements (7,8).

An alternative design of the head element (1) is illustrated on the left hand side of FIG. 4. In this case, the upper transparent housing (2) is spaced from the display elements (7,8).

When the batteries (22) require changing, the housing (12) is disconnected from the head element (1) by releasing the collar (13). New batteries can then be installed and the collar (13) retightened. This action automatically connects the batteries into the circuit and so the electronic controls operate immediately. Since the probes themselves may require changing periodically, these too may be changed in a similar way. Preferably however, the probe (17) is fixed into the housing (12) permanently, to minimise the risk of water leakage, and therefore the entire housing (12) with the probe (17) is discarded at this time and replaced by a new unit.

The device of the invention can provide continuous and reliable monitoring of the conditions of a liquid such as water in a swimming pool. It requires little maintenance and is easy to read. Measurements taken are at the optimum depth in the water.

1. A liquid monitoring device which floats in liquid, comprising a signal element able to indicate a property of liquid and arranged to float above the surface of said liquid, an elongate housing extending below said signal element and arranged so that it is below the surface of liquid when the device is floating therein, and a sensor arranged at an end region of said housing remote from the signal element and arranged to measure at least one property of said liquid, and means for transmitting information from said sensor to said signal element.

2. A liquid monitoring device according to claim 1 wherein said elongate housing is such that the sensor is located from 15 to 45 cm below the surface of the liquid in which the device is placed.

3. A liquid monitoring device according to claim 2 wherein the housing is from 28 to 32 cm long.

4. A liquid monitoring device according to claim 1, wherein the said sensor is adapted to measure temperature, pH, and/or chemical composition of said liquid.

5. A liquid monitoring device according to claim 1, wherein the sensor, the means for transmitting information from said sensor to said signal element and/or the signal element are battery operated.

6. A liquid monitoring device according to claim 5 wherein the elongate housing is adapted to accommodate one or more batteries required to operate said sensor, the means for transmitting information from said sensor to said signal element and/or the signal element.

7. A liquid monitoring device according to claim 5 further comprising solar cells which are arranged to operate the sensor, the means for transmitting information from said sensor to said signal element and/or the signal element.

8. A liquid monitoring device according to claim 1, wherein the sensor, the means for transmitting information from said sensor to said signal element and/or the signal element is powered by solar cells.

9. A liquid monitoring device according to claim 1, wherein the signal element comprises a display, housed within a transparent container.

10. A liquid monitoring device according to claim 9 wherein the display is a digital display.

11. A liquid monitoring device according to claim 1, wherein the said signal element comprises a transmitter, able to transmit information to a remote receiving station.

12. A liquid monitoring device according to claim 1, wherein the said elongate housing is removable.

13. A liquid monitoring device according to claim 1, which further comprises a buoyancy aid, arranged to maintain the device floating in liquid such that the signal element is above the waterline and the elongate housing below the waterline.

14. An elongate housing for use in a device according to claim 1.

15. A combination of an elongate housing and a sensor for use in a device according to claim 1.

16. (canceled)
